(19) United States
(12) Patent Application Publication
(10) Pub. No.: US 2011/0046873 A1
(43) Pub. Date: Feb. 24, 2011

(54) SIGNALIZED INTERSECTION INFORMATION ACQUIRING DEVICE, SIGNALIZED INTERSECTION INFORMATION ACQUIRING METHOD, AND SIGNALIZED INTERSECTION INFORMATION ACQUIRING PROGRAM

(75) Inventor: Kenji Nagase, Okazaki (JP)

Correspondence Address: SUGHRUE MION, PLLC, 2100 PENNSYLVANIA AVENUE, N.W., SUITE 800, WASHINGTON, DC, 20037, US

(73) Assignee: Aisin AW Co., Ltd., Anjo-shi, Aichi-ken (JP)

(21) Appl. No.: 12/922,614

(22) PCT Filed: Feb. 27, 2009
(86) PCT No.: PCT/JP2009/000880

§ 371 Date: Sep. 14, 2010

(30) Foreign Application Priority Data
Mar. 28, 2008 (JP) 2008-086840

(51) Int. Cl. G01C 21/34; G08G 1/07

(52) U.S. Cl. 701/200; 340/916

(57) ABSTRACT

In order to precisely specify a lighting pattern of an actual traffic signal, traveling direction information indicating a traveling direction of a vehicle at a signalized intersection is acquired from a plurality of vehicles, and the information on the lighting pattern of the traffic signal at the signalized intersection is acquired based on the traveling direction information of the plurality of vehicles.

### TECHNICAL FIELD

The present invention relates to a signalized intersection information acquiring device, a signalized intersection information acquiring method, and a signalized intersection information acquiring program for acquiring information on a lighting pattern of a traffic light.

### BACKGROUND ART

Conventionally, there has been known technologies for setting a passing cost at a signalized intersection, and for searching route based on the passing cost. For example, in Japanese Patent Application Publication No. 2005-321360, there has been known the technology for setting cost information for searching route depending on presence of a traffic light or presence of an arrow signal of the traffic light.

### Patent Citation 1: Japanese Patent Application Publication No. 2005-321360

### DISCLOSURE OF INVENTION

### Technical Problem

In the conventional technologies, it has not been possible to set the cost information precisely reflecting the lighting pattern of an actual traffic signal.

Specifically, the difficulty in traveling when passing the actual traffic signal depends on not only presence of the traffic light or presence of the arrow signal but the lighting pattern (type of lighting lamp) or lighting duration time of any lighting pattern. Hence, it is not possible to set the cost information precisely reflecting the difficulty in traveling at the signalized intersection merely based on the presence of the traffic light or the presence of the arrow signal.

In light of the aforementioned problem, an object of the present invention is to precisely specify a lighting pattern of an actual traffic signal.

### Technical Solution

To attain the object, in the present invention, the information on the lighting pattern of the traffic light at the signalized intersection is acquired based on traveling direction information indicating a traveling direction of a vehicle at a signalized intersection. In other words, it is assumed that the vehicles travel merely in the traveling direction permitted by the lighting pattern of the traffic signal at the signalized intersection. Therefore, the traveling direction of the vehicles at the signalized intersection can be considered as corresponding to the lighting pattern of the traffic signal at the signalized intersection. Hence, when the traveling direction information of a plurality of vehicles is acquired, it is possible to specify the lighting pattern based on the traveling direction information of the plurality of vehicles.

Now, it is sufficient that traveling direction information acquiring unit can acquire the information on the traveling direction of the vehicle at the signalized intersection. The information may be the information on physical change of the vehicle, such as position change, velocity change, or acceleration change of the vehicle, the information that can determine an approach direction to the signalized intersection and a leaving direction therefrom, or the information on the road section where the vehicle travels and the direction thereof before and after the intersection. Thus, the traveling direction information acquiring unit can employ various configurations.

It is sufficient that lighting pattern information acquiring unit can acquire the information on the lighting pattern of the traffic signal based on the traveling direction information of a plurality of vehicles. In other words, when the traveling directions of the plurality of vehicles at a signalized intersection are acquired, it becomes possible to specify the traveling directions of the vehicles which are permitted by the traffic signal at the signalized intersection. Since the permitted traveling directions of the vehicles correspond to the lighting pattern of the traffic signal, it becomes possible to specify the lighting pattern of the traffic signal at the signalized intersection based on the traveling directions of the plurality of vehicles.

Note that it is sufficient that the information on the lighting pattern of the traffic signal corresponds to the traveling direction which is permitted for the vehicles at the signalized intersection, and thus the information on the position and color of the lighting lamp of the traffic signal or the like can be employed. Of course, since the lighting pattern would be switched depending on time in the traffic signal, the information on the lighting pattern preferably includes the information on each lighting pattern which is switched depending on time. Alternatively, the information may be associated with the lighting duration time during which a specified lighting pattern continues.

Moreover, it may be configured such that the information on the lighting pattern includes the information that specifies a switching timing of the lighting pattern. For example, it may be configured such that the traveling direction information includes the information on the time when the vehicle passes the signalized intersection, and thereby the approach direction when the vehicle approaches to the signalized intersection is specified based on the traveling direction of the vehicles and the aforementioned time. Then, it is possible to employ the configuration in which the time zone, in which the specified approach direction is continuously observed, is specified and the breakpoint of the time zone is provided as a switching timing of the lighting pattern.

Usually, the general traffic signal temporarily allows the passage of the vehicle approaching to the signalized intersection in a specified approach direction, and temporarily prohibits the passage of the vehicle approaching to the signalized intersection in approach directions other than the specified approach direction. Such permission and prohibition of the vehicles' passage are determined by the lighting pattern. The vehicles approaching to the signalized intersection in the specified approach direction continuously appear until the lighting pattern is switched. When the lighting pattern is switched, the specified approach direction in which the vehicles can approach to the signalized intersection is changed.

Therefore, it is possible to specify the time zone in which the specified approach direction is continuously observed by aggregating the approach directions and the times of the plurality of vehicles. Moreover, since the permitted approach direction is common (or partially common) in the time zone, it is possible to specify the switching timing of the lighting pattern by a breakpoint of the time zone.

Note that it is sufficient that the specified approach direction corresponds to the lighting pattern of the traffic signal, and when the traffic signal simultaneously allows the approach from a plurality of approach directions, the specified approach direction may be a plurality of approach direction. For example, when, at the intersection where straight roads cross, the signalized intersection allows the passage of both vehicles, the vehicle traveling in one direction and the vehicle traveling in the opposite direction, the approach directions which are opposite to each other for both vehicles are considered as the specified approach direction. In some cases, of course, both vehicles traveling in the perpendicular directions are allowed to approach to the signalized intersection as long as the vehicles leave in a specified leaving direction at the intersection where the straight roads cross. In such case, each direction is considered as the specified approach direction.

Moreover, it is sufficient that the information on the passing time through the signalized intersection is the information for directly or indirectly specifying the time at which the vehicles pass through the signalized intersection. The information on an approach/leaving time to/from the signalized intersection, the time when the vehicles travel before and after the signalized intersection, or the like can be employed.

Furthermore, it can be configured so as to deal with the complex traffic signal which, in the specified time zone, maintains the state in which the vehicle approaching to the signalized intersection in the specified approach direction is allowed to pass while, in the middle of the time zone, it allows only the passage of the vehicle leaving in a specified leaving direction and prohibits the leaving of the vehicle in other leaving directions. For example, it is configured to specify, based on the traveling direction and the time, the leaving direction when the vehicle leaves from the signalized intersection, and it is configured to specify the specified leaving time zone in which only the specified leaving direction is continuously observed for each time zone in which the specified approach direction is continuously observed. Then, the breakpoint of the time zone is considered as a switching timing of the lighting pattern.

In other words, the time zone in which a leaving direction is restricted to a specified leaving direction is specified, the time zone is considered as a specified leaving time zone, and thereby the breakpoint of the specified leaving time zone can be regarded as a switching timing of the lighting pattern. With this configuration, it is possible to specify the lighting pattern and the switching timing regarding even the traffic signal having the complex lighting patterns.

Note that when the aforementioned time zone and the specified leaving time zone are specified, it is possible to specify a lighting duration time of the lighting pattern based on the time zone and/or the specified leaving time zone. In other words, when the length of the aforementioned time zone is specified, it is possible to define the lighting duration time for the lighting pattern which corresponds to the approach direction to the signalized intersection permitted in the time zone. Similarly, when the aforementioned specified leaving time zone is specified, it is possible to define the lighting duration time for the lighting pattern which corresponds to the leaving direction from the signalized intersection permitted in the specified leaving time zone.

Moreover, the information on difficulty in traveling at the signalized intersection may be acquired based on the information on lighting pattern. For example, the lighting duration time of the lighting pattern corresponds to the time during which the state where the traveling in the specified approach direction is permitted by the lighting pattern is being maintained. As the lighting duration time is longer, it is easier to pass the signalized intersection, and as the lighting duration time is shorter, it is more difficult to pass the signalized intersection. Therefore, the length of the lighting duration time indicates the difficulty in traveling when traveling in the specified traveling direction at the signalized intersection.

Therefore, it is possible to acquire the information on the difficulty in traveling when traveling in the specified traveling direction at the signalized intersection by acquiring the lighting duration time. Specifically, the index (e.g., the cost information) indicating the difficulty in traveling may be set such that as the lighting duration time is longer, the difficulty in traveling becomes less.

Furthermore, it is possible to apply to a program and a method, the techniques for acquiring the information on the lighting pattern of the traffic signal based on the traveling direction of the vehicle at the signalized intersection according to the present invention. The foregoing device, program, and method for acquiring the information on the signalized intersection include various aspects; they are provided as a single signalized intersection information acquiring device in some cases, and are provided using the common component to each part constituting the vehicle in other cases. For example, it is possible to provide a navigation device, method, and program with the foregoing signalized intersection information acquiring device. Moreover, it is possible to change the signalized intersection information acquiring device appropriately such as partially software and partially hardware. Furthermore, the invention is also realized as a recording media of the program controlling the signalized intersection information acquiring device. Of course, the recording media of the software may be magnetic recording media or magneto-optical media, and any recording media to be developed in the future can be assumed in the totally same manner.

### BRIEF DESCRIPTION OF THE DRAWINGS

FIG. 1 is a block diagram illustrating a system configuration including a signalized intersection information acquiring device and a navigation device;

FIG. 2 is a flow chart illustrating a signalized intersection information acquiring processing;

FIGS. 3A and 3B are diagrams illustrating examples to explain lighting patterns;

FIGS. 4A and 4B are diagrams illustrating other examples to explain the lighting patterns;

FIG. 5 is a diagram illustrating an example to explain a lighting pattern; and

FIG. 6 is a diagram illustrating another example to explain the lighting pattern.

### BEST MODE FOR CARRYING OUT THE INVENTION

Here, embodiments of the present invention will be described in the following order:

(1) Configuration of Road Information Generating System

(1-1) Configuration of Signalized Intersection Information Acquiring Device

(1-2) Configuration of Navigation System

(2) Signalized Intersection Information Acquiring Processing

(3) Other Embodiments

### 1 Configuration of Road Information Generating System

(1-1) Configuration of Signalized Intersection Information Acquiring Device

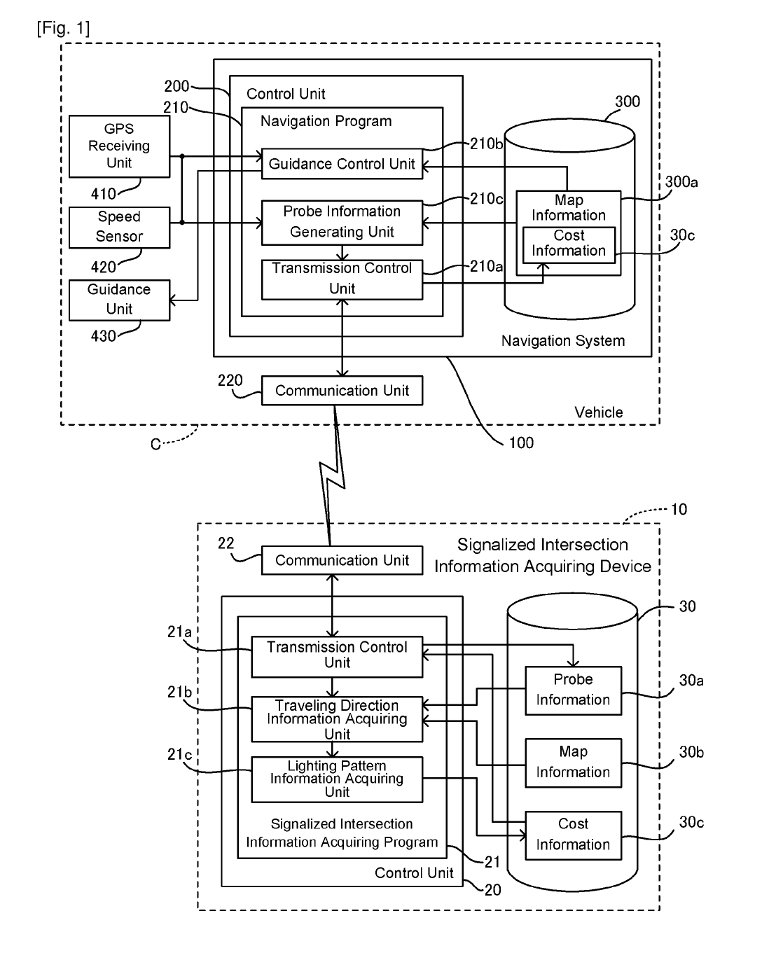

FIG. 1 is a block diagram illustrating a configuration of a system comprising a signalized intersection information acquiring device 10, which is placed in the road information control center, and a navigation system 100 equipped in a vehicle C. The signalized intersection information acquiring device 10 comprises a control unit 20 having CPU, RAM, ROM or the like, and a storage medium 30. The control unit 20 can execute programs stored in the memory medium 30 or ROM. In this embodiment, a signalized intersection information acquiring program 21 is executable as one of the programs, and the control unit 20 acquires the information on the lighting pattern of the traffic light at the signalized intersection by the processing of the signalized intersection information acquiring program 21.

In this embodiment, the information on the lighting pattern is generated based on the probe information which is output by a plurality of vehicles C. Moreover, the signalized intersection information acquiring device 10 generates cost information based on the information on the lighting pattern, and transmits the cost information to the vehicle C. The signalized intersection information acquiring device 10 thus comprises a communication unit 22 which is made up of a circuit for communicating with the navigation system 100. The control unit 20 can receive the probe information via the communication unit 22 and transmit the cost information.

The signalized intersection information acquiring program 21 comprises a transmission control unit 21a, a traveling direction information acquiring unit 21b, and a lighting pattern information acquiring unit 21c so as to acquire the information on the lighting pattern and generate and transmit the cost information. By the processing of the signalized intersection information acquiring program 21, the control unit 20 realizes the functions for generating the cost information and providing the information to the vehicle C in cooperation with the communication unit 22, the storage medium 30, or RAM or the like in the control unit 20.

The transmission control unit 21a is a module for controlling the communication to the vehicle C. The control unit 20 controls the communication unit 22 by the processing of the transmission control unit 21a, and communicates with the communication unit 220 mounted on each of the plurality of vehicles C. Therefore, the probe information transmitted from the vehicle C is acquired, and is recorded to the storage medium 30 with the information being able to be identified as the information acquired from the same vehicle C (probe information 30a illustrated in FIG. 1). Moreover, cost information 30c generated by the processing set forth below is acquired and transmitted to the vehicle C.

It is noted that the probe information 30a in this embodiment includes at least the traveling direction of the vehicle C at the signalized intersection. In this embodiment, the probe information 30a includes a link number indicating a road section (link) between nodes set to the road, a traveling direction when the vehicle C travels in the road section corresponding to the link number (the node associated with the start of traveling and the node associated with the end thereof), start and end times for the vehicle C traveling in the road section corresponding to the link number, and an identifier indicating that the information is acquired from the same vehicle C.

Furthermore, in this embodiment, the storage medium 30 in advance stores map information 30b which includes the information on a node position set on the roads and the information on the link number to identify the link (road section) indicating the linkage of nodes. Each node is associated with attribute information which includes the information on whether the node is a signalized intersection or not. In this embodiment, the traveling direction information includes the information on the link number, the traveling direction at the link, and the node position; the attribute information of the node; the time information; and the identifier indicating that the information is from the same vehicle.

The traveling direction information acquiring unit 21b is a module for acquiring the traveling direction information at the signalized intersection based on the probe information 30a acquired in the aforementioned manner and the above map information 30b. Therefore, the control unit 20 refers to the probe information 30a recorded in the storage medium 30 and the above map information 30b, and acquires the traveling direction information on the node corresponding to the signalized intersection by the processing of the traveling direction information acquiring unit 21b.

The lighting pattern information acquiring unit 21c is a module for acquiring the information on the lighting pattern of the traffic signal at the signalized intersection based on the above traveling direction information. In this embodiment, the control unit 20 specifies the approach direction of the vehicle C with respect to the signalized intersection and the leaving direction of the vehicle C therefrom based on the traveling direction information by the processing of the lighting pattern information acquiring unit 21c. Moreover, the lighting pattern of the traffic light is specified based on these approach directions.

To sum up, in this embodiment, the control unit 20 specifies the road section linked to the node which corresponds to any signalized intersection based on the traveling direction information, and specifies the approach direction to the signalized intersection based on the relationship between the road section, in which the vehicle C had driven before the vehicle C passed the signalized intersection, and the signalized intersection. Moreover, the control unit 20 specifies the leaving direction from the signalized intersection based on the relationship between the road section, in which the vehicle C has driven after the vehicle C passed the signalized intersection, and the signalized intersection.

Furthermore, the control 20 specifies the time when the vehicle C passes the signalized intersection based on the above time information (e.g., specifies the end time of traveling in the road section of which the end is located at the signalized intersection, or the start time of traveling in the road section of which the beginning is located at the signalized intersection), and specifies the time zone in which a specified approach direction is continuously observed. Then, the breakpoints of the time zone are considered as switching timing of the lighting pattern. Usually, the general traffic signal temporarily permits the passage of the vehicle approaching to the signalized intersection in the specified approach direction, and temporarily prohibits the passage of the vehicle approaching there in the approach direction other than the specified approach direction. The lighting pattern specifies such permission and prohibition of the vehicle's passage. Until the lighting pattern is switched, the vehicles approaching to the signalized intersection in the specified approach direction continuously appear. When the lighting pattern is switched, the specified approach direction permitting the vehicles to approach to the signalized intersection is changed.

Therefore, if the approach directions to the signalized intersection and the times thereof are aggregated for the plurality of vehicles, it is possible to specify the time zone in which the specified approach direction is continuously observed. Moreover, since the permitted traveling direction is common (or partially common) in the time zone, the switching timing of the lighting pattern can be specified by the breakpoints of the time zone and the lighting duration time can be specified.

It is noted that the specified approach direction may correspond to the lighting pattern of the traffic signal. Thus, since the traffic signal according to this embodiment simultaneously permits the approach from the plurality of approach directions, the plurality of approach directions which are simultaneously permitted are defined as specified directions. For example, at the intersection at which the straight roads cross, when the signalized intersection permits both type of vehicles, i.e., the vehicles traveling in one direction on the straight road and the vehicles traveling in the other direction, to drive, the approach directions of both type of vehicles, which are opposite to each other, are considered as the specified directions.

Moreover, in this embodiment, the lighting pattern is analyzed in detail to specify the time when the vehicle C passes the signalized intersection and specify a specified leaving time zone in which only the specified leaving direction is continuously observed. Then, the breakpoints of the specified leaving time zone are considered as the switching timing of the lighting pattern. In other words, it is assumed that the traffic signal has the lighting pattern permitting only the traveling in the leaving direction which is observed in each specified leaving time zone, and the lighting pattern is specified and the lighting duration time is also specified.

In this embodiment, the cost information 30c is further generated based on the lighting duration time. Specifically, the control unit 20 determines that it is easy to pass the signalized intersection as the lighting duration time is longer and it is difficult to pass the signalized intersection as the lighting duration time is shorter. Then, a cost, which is an index showing the difficulty in traveling, is set such that the difficulty in traveling becomes less as the lighting duration time is longer, and the cost is recorded to the storage medium 30 as the cost information 30c. According to the foregoing processing, the cost information 30c precisely reflecting the lighting pattern of the actual traffic signal can be generated, and the route search and the route guide can be conducted in accordance with the lighting pattern of the traffic signal by using the cost information 30c in the vehicle C.

(1-2) Configuration of Navigation System

A navigation system 100 is mounted to the vehicle C traveling on the roads. The navigation system 100 comprises a control unit 200 with CPU, RAM, ROM or the like, and a storage medium 300. The control unit 200 can execute programs stored in the storage medium 300 or ROM. In this embodiment, a navigation program 210 can be executed as one of the programs, and the navigation program 210 makes it possible to search route using the aforementioned cost information 30c. Moreover, the vehicle C according to this embodiment can generate and transmit the probe information 30a based on the traveling history on the roads.

As such, the vehicle C comprises a communication unit 220 which is made up of a circuit for communicating with the signalized intersection information acquiring device 10. The control unit 200 can transmit the probe information 30a via the communication unit 220 and receive the cost information 30c by the processing of a transmission control unit 210a. The cost information 30c acquired by the processing of the transmission control unit 210a is recorded in the storage medium 300 along with the map information 300a. Specifically, the map information 300a including the similar information to the map information 30b is predefined and recorded in the storage medium 300, and the cost information 30c is recorded with being incorporated into the map information 300a while associating the cost information 30c with the link between nodes indicated by the map information 300a.

Moreover, the vehicle C comprises a GPS receiving unit 410, a speed sensor 420, and a guidance unit 430. The GPS receiving unit 410 receives radio waves from a GPS satellite, and outputs information for calculating the current position of the vehicle via interface (not shown). The control unit 200 acquires this signal and acquires the current position of the vehicle. The speed sensor 420 outputs a signal associated with the rotational speed of the wheel of the vehicle C. The control unit 20 acquires the signal via the interface not shown, and acquires the speed of the vehicle C. The speed sensor 420 is used e.g., to correct the current position of the vehicle C specified from the output signal of the GPS receiving unit 410. The current position of the vehicle C is corrected appropriately based on the travel trajectory of the vehicle C. It is noted that the configuration for acquiring the information on the vehicle motion can employ other various configurations such as the configuration in which the current position of the vehicle C is corrected based on the output signal of a gyro sensor or specified by a sensor or a camera, the configuration in which vehicle C motion information is acquired by signals from the GPS, the travel trajectory of the vehicle on the map, vehicle-to-vehicle communication, road-to-vehicle communication or the like.

The navigation program 210 comprises a guidance control unit 210b for performing the route search using the cost information 30c, comprises a probe information generating unit 210c for generating the probe information 30a, and cooperates in conjunction with the communication unit 220, the storage medium 300 or RAM or the like in the control unit 200. The guidance control unit 210b is a module for receiving the input of destination by an input unit not shown, searching routes to the destination from the traveling start point, and outputting the guidance for having the vehicle traveled on the route to the guidance unit 430 (display or the like).

To sum up, the control unit 200 performs route search based on the cost information 30c, and controls the guidance unit 430 to provide guidance of the searched route. This makes it possible to guide the route reflecting the lighting pattern of the traffic signal as a candidate route to the destination and it is possible to travel on the route in which the signalized intersection to be easily passed is selected.

The probe information generating unit 210c is a module for generating the probe information 30a associated with the motion of the vehicle C. The control unit 200 acquires the output signal of the GPS receiving unit 410 by the processing of the probe information generating unit 210c to specify the position of the vehicle C (latitude and longitude). Then, the probe information 30a is generated based on the motion of the vehicle C. Specifically, the information on the link number of the road section where the aforementioned vehicle C traveled, the traveling direction in the road section, and the start time and the end time of the traveling in the road section are acquired with reference to the map information 300a. Moreover, the control unit 200 associates an identifier indicating the aforementioned vehicle C with the information, and generates the probe information 30a. When the probe information 30a is generated, the control unit 200 transmits the probe information 30a to the signalized intersection information acquiring device 10 via the communication unit 220 by the processing of the transmission control unit 210a.

### 2 Signalized Intersection Information Acquiring Processing

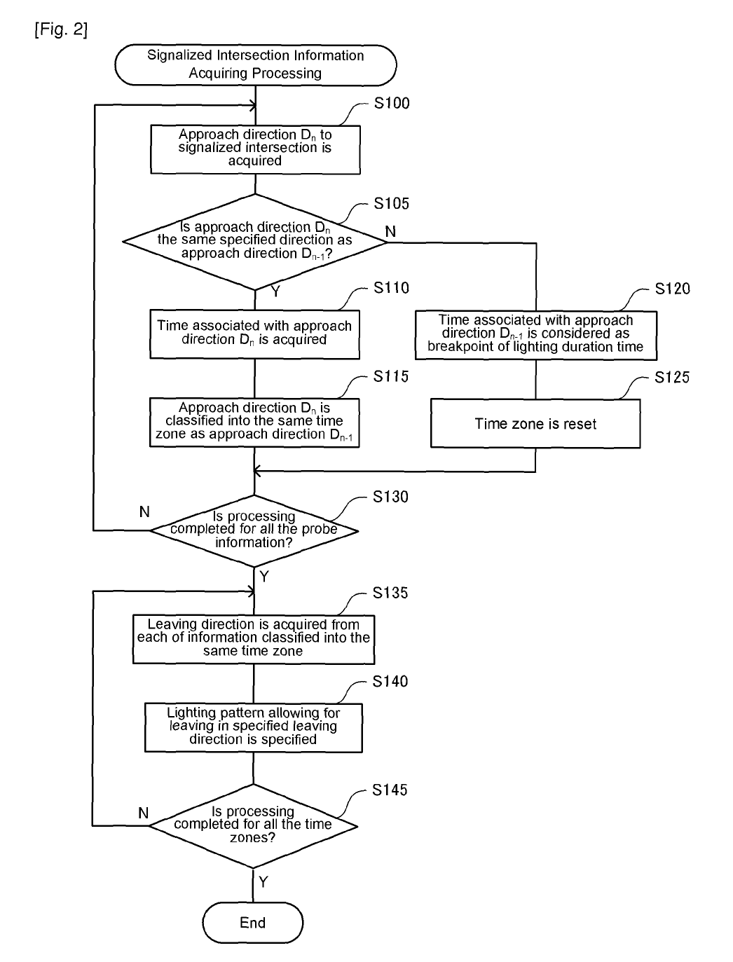

Next, a signalized intersection information acquiring processing in the aforementioned configuration will be described in detail. FIG. 2 is a flowchart showing the signalized intersection information acquiring processing. In this embodiment, the control unit 20 sequentially receives the probe information 30a transmitted from the vehicle C by the processing of the transmission control unit 21a and records it to the storage medium 30. Under such condition, the processing shown in FIG. 2 is conducted to specify the lighting pattern at each of the signalized intersections by analyzing the probe information 30a acquired at a predetermined time interval.

In this processing, the control unit 20 conducts the processing to generally specify the lighting pattern of the traffic signal at the signalized intersection based on the approach direction (Steps S100 to S130) and then specify the lighting pattern in detail based on the leaving direction (Steps S135 to S145). In this embodiment, in order to generally specify the lighting pattern based on the approach direction of the vehicle C to the signalized intersection, the time zone when the same approach direction is continuously observed is specified in advance. Therefore, at first, the control unit 20 acquires an approach direction Dₙ (n refers to the number of repetition of Steps S100 to S130) to the signalized intersection by the processing of the traveling direction information acquiring unit 21b and the lighting pattern information acquiring unit 21c (Step S100). Specifically, the control unit 20 specifies the signalized intersection of which the lighting pattern is to be analyzed with reference to the map information 30b, and sequentially refers to the traveling direction information in the order of probe information 30a acquired at earlier time. Then, the control unit 20 acquires the approach direction to the signalized intersection based on the traveling direction information.

Next, the control unit 20 determines whether the approach direction Dₙ acquired in Step S100 is the same specified direction as the last acquired approach direction Dₙ₋₁ by the processing of the lighting pattern information acquiring unit 21c (Step S105). In general, the traffic signal permits the approach to the signalized intersection from the plurality of approach directions in the specified lighting pattern. Thus, the approach directions which are simultaneously permitted by the specified lighting pattern are defined in advance as specified directions as mentioned above. In Steps S100 to S130, the processing, in which the probe information 30a is sequentially acquired in the order of earlier time to acquire the approach direction indicated by each of the probe information 30a, is repeated. In Step S105, the approach direction Dₙ is compared with the approach direction Dₙ₋₁, to determine whether the both directions are the specified direction permitted by the same lighting pattern. Note that there is no last approach direction Dₙ₋₁ in the first repetitive processing and the lighting pattern is determined not to be the same.

In Step S105, when the approach direction Dₙ is determined to be the same specified direction to the approach direction Dₙ₋₁, the control unit 20 acquires the time associated with the approach direction Dₙ (passage time of the signalized intersection, which is specified from the aforementioned time information included in the probe information 30a on which the approach direction Dₙ is based) by the processing of the lighting pattern information acquiring unit 21c (Step S110). Moreover, the control unit 20 classifies the current approach direction Dₙ into the same time zone as the last approach direction Dₙ₋₁ by the processing of the lighting pattern information acquiring unit 21c (Step S115).

On the other hand, when the approach direction Dₙ is determined not to be the same specified direction as the approach direction Dₙ₋₁ in Step S105, i.e., when the approach direction Dₙ₋₁, which is acquired by the last repetitive processing, is different from the approach direction Dₙ, the control unit 20, by the processing of the lighting pattern information acquiring unit 21c, provides the time associated with the last approach direction Dₙ₋₁ as a breakpoint of lighting duration time of the lighting pattern permitting the approach direction Dₙ₋₁ (Step S120). Then, the control unit 20 resets the time zone by the processing of the lighting pattern information acquiring unit 21c (Step S125). In other words, the control unit 20 sets a new time zone other than the time zone which has been set as the time zone in which the approach direction Dₙ₋₁ is continuously observed, and classifies the approach direction Dₙ into the new time zone. According to the above processing, the time zone in which the approach direction corresponding to the same specified direction is continuously observed is set and the breakpoint of the time zone is set as a switching timing of the lighting pattern. In Step S125, each lighting pattern and the lighting duration time thereof are recorded in the storage medium 30 with being associated with each other.

After Steps S115 and S125 are completed, the control unit 20, by the processing of the lighting pattern information acquiring unit 21c, determines whether the processing for acquiring the approach direction is conducted for all the probe information which is to be analyzed (Step S130), and repeats the processing provided after Step S100 until the processing for acquiring the approach direction is conducted for all the probe information.

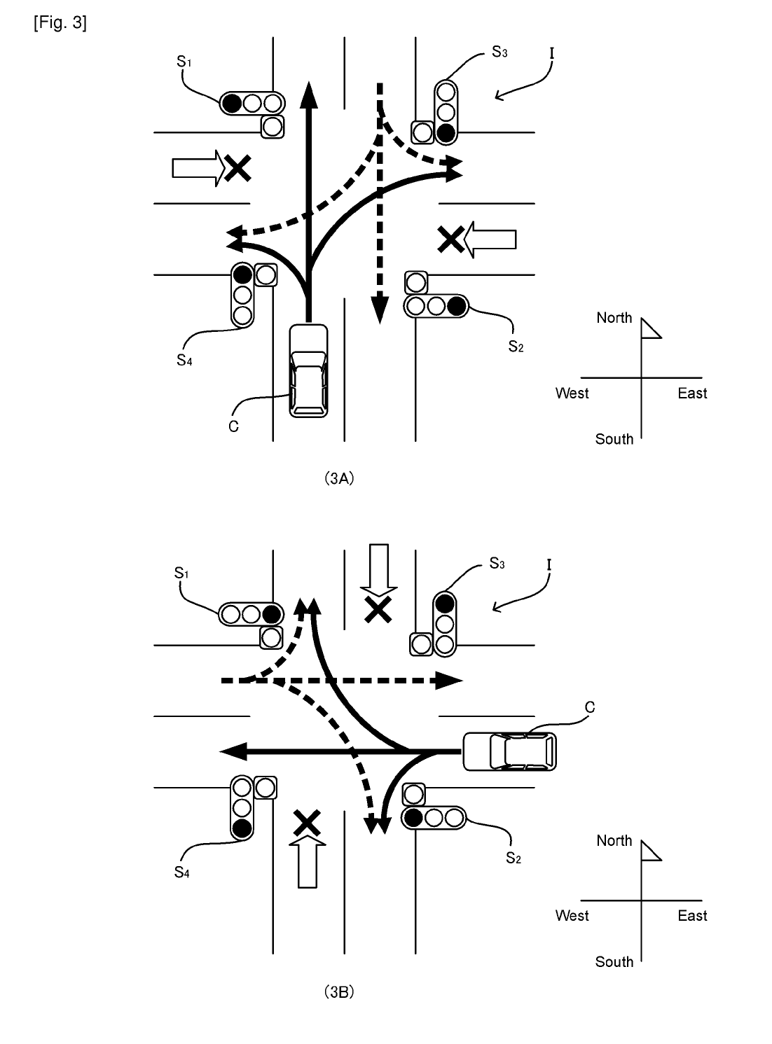

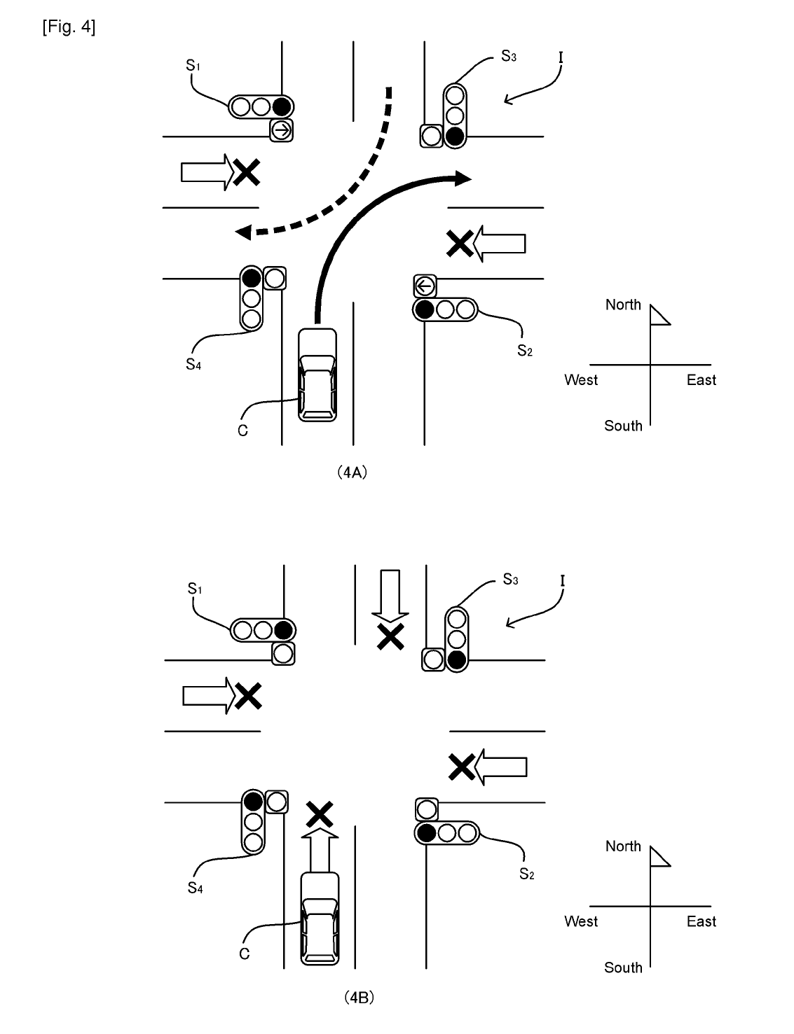

FIGS. 3 to 5 are diagrams showing an example for explaining the lighting pattern. FIGS. 3 and 4 show a signalized intersection I at which the roads extending in the north-south direction and the east-west direction cross, and designate the traffic signal for the vehicles traveling from south to north as traffic signal S₁, the traffic signal for the vehicles traveling from north to south as traffic signal S₂, the traffic signal for the vehicles traveling from west to east as traffic signal S₃, and the traffic signal for the vehicles traveling from east to west as traffic signal S₄. In each of the traffic signals S₁ to S₄, the lamp provided on the observers' left indicates the permission of passage, the lamp provided on the observers' right indicates the prohibition of passage, and the lamp provided at the center urges the stop. Moreover, the lamp placed under the right lamp indicates an arrow signal while the right lamp is lighting, thereby permitting only right turn.

In FIGS. 3 and 4, the lighting of the lamps of the traffic signals S₁ to S₄ is denoted by black circle or black arrow, the approach direction allowed for the vehicle is denoted by solid or dashed arrow, and the approach direction prohibited is denoted by outline arrow. FIG. 3A illustrates the state in which the left lamps of the traffic signals S₁ and S₂ are lighting and the right lamps of the traffic lamps S₃ and S₄ are lighting. The lighting pattern illustrated in FIG. 3A permits the passage of the vehicle approaching to the signalized intersection in the northward and southward approach directions, prohibits the passage of the vehicles approaching to the signalized intersection in the eastward and westward approach directions. Similarly, FIG. 3B illustrates the state in which the right lamps of the traffic signals S₁ and S₂ and left lamps of the traffic signals S₃ and S₄ are lighting, i.e., the lighting pattern permitting the approach to the signalized intersection in the eastward and westward approach directions and prohibiting the approach thereto in the northward and southward approach directions.

At the signalized intersection I shown in the foregoing example, there are two lighting patterns: the lighting pattern which permits the passage of the vehicle approaching to the signalized intersection I in the northward and southward approach directions, and the lighting pattern which permits the passage of the vehicle approaching to the signalized intersection I in the eastward and westward approach directions. Therefore, in this example, the northward and southward approach directions are regarded as the same specified direction and the eastward and westward approach directions are as the same specified direction.

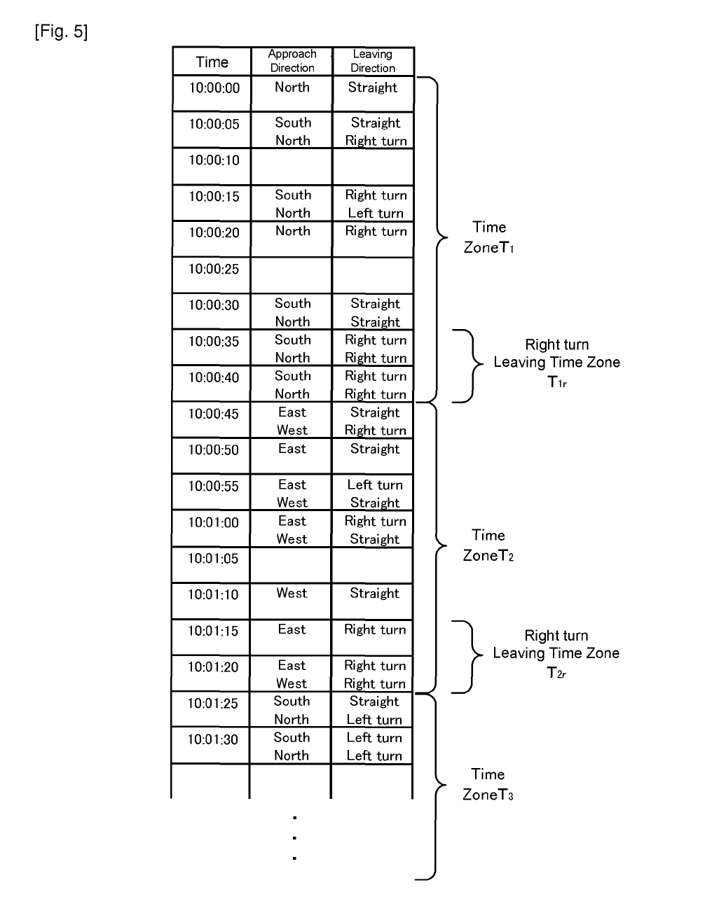

FIG. 5 is a diagram showing an example of the approach direction and the leaving direction of the vehicles which pass the signalized intersection I in units of the time interval of five seconds from the time 10:00:00. For example, FIG. 5 shows that one vehicle approached to the signalized intersection I from south toward north, ran straight, and left to the north road during the five seconds from the time 10:00:00, that one vehicle approached to the signalized intersection I from north toward south and then ran straight during five seconds from the time 10:00:05, and that one vehicle approached to the signalized intersection I from south to north and then right turned. Note that in the example shown in FIG. 5, there is no vehicle passing the signalized intersection I during five seconds from the time 10:00:10.

FIG. 5 shows the motions of the vehicles passing through the signalized intersection I in each time interval from the time 10:00:00 until 10:01:35 as mentioned above. In this example, when Steps S100 to S130 illustrated in the above FIG. 2 are executed, for the information on 12 vehicles at and after the time 10:00:00, the approach directions are determined as the same specified direction. In other words, since the approach directions according to the information on 12 vehicles are north or south, the approach directions are determined as the same specified direction corresponding to the same lighting pattern (FIG. 3A). As a result, the time associated with the approach direction of each vehicle is acquired, and the approach direction of each vehicle is classified into the same time zone (time zone T₁ as shown in FIG. 5). This makes it clear that the time zone, in which the north and south approach directions are allowed, is at and after 10:00:00 and before 10:00:45.

Similarly, according to the information on 11 vehicles at and after the time 10:00:45, the approach direction is eastward or westward, which are the same specified direction. Therefore, the approach directions of the 11 vehicles are classified into the same time zone (time zone T₂ shown in FIG. 5), and the time zone, in which the eastward and westward approach directions are allowed, is at and after 10:00:45 and before 10:01:25. After this, by repeating the similar processing, it is possible to specify the time zone having the lighting pattern which permits the northward and southward approach directions and the time zone having the lighting pattern which permits the eastward and westward approach directions, and thus the lighting duration time of each lighting pattern can be specified.

In Step S130, when it is determined that the processing for acquiring the approach direction is completed for all the probe information, the detail lighting pattern is specified based on the lighting pattern which is generally specified by the aforementioned processing. Specifically, the processing for determining whether the arrow signal is lighting in the lighting pattern is conducted.

For this, the control unit 20 acquires the leaving direction from each information classified into the same time zone by the processing of the lighting pattern information acquiring unit 21c (Step S135). Specifically, the control unit 20 specifies the signalized intersection of which the lighting pattern is to be analyzed with reference to the map information 30b, and acquires the probe information 30a in the order of earlier time to sequentially acquire the leaving direction from the signalized intersection based on the traveling direction information.

Then, the control unit 20 specifies the lighting pattern which permits the leaving in the specified leaving direction by the processing of the lighting pattern information acquiring unit 21c (Step S140). Specifically, the control unit 20 refers to the leaving direction in each of the aforementioned time zones (time zone T₁ and T₂ shown in FIG. 5), and specifies the specified leaving time zone in which only the specified leaving direction is continuously observed. In this embodiment, the specified leaving time zone begins in the middle of the aforementioned time zone, permits only the passage of the vehicle leaving in the specified leaving direction, and prohibits the leaving in other leaving directions. Specifically, in the specified leaving time zone, the plurality of leaving directions (straight, right turn, and left turn in the example illustrated in FIG. 3), which had been permitted in the aforementioned time zone, are reduced, and only some of the leaving directions are allowed. Hence, the breakpoint (start point) of the specified leaving time zone serves as a switching timing of the lighting pattern. In this embodiment, the length of the specified leaving time zone is considered as the lighting duration time of the lighting pattern permitting only the specified leaving direction, and the length of the specified leaving time zone and the lighting duration time are recorded to the storage medium 30 with being associated with each other.

Moreover, the control unit 20 determines whether the processing of Steps S135 and S140 is completed for all the time zones by the processing of the lighting pattern information acquiring unit 21c (Step S145), and repeats the processing of Steps S135 and S140 with changing the time zone until the processing is determined to be completed.

FIG. 4A shows that the right lamps of the traffic signals S₁ to S₄ are lighting and the rightward arrow signals of the lamps placed under the right lamps of the traffic signals S₁ and S₂ are lighting. The lighting pattern illustrated in FIG. 4A is a lighting pattern which permits the passage of the vehicle approaching to the signalized intersection in the northward direction and leaving therefrom (right turn) in the eastward direction and the vehicle approaching to the signalized intersection in the southward direction and leaving therefrom (right turn) in the westward direction. In other words, FIG. 4A illustrates the lighting pattern in the right-turn-only time zone provided for the vehicle approaching to the signalized intersection in the northward or southward direction.

Note that the lighting pattern illustrated in FIG. 4A is generated after the lighting pattern illustrated in FIG. 3A. For example, in the example shown in FIG. 5, in the time zone at and after the time 10:00:00 and before the time 10:00:45, only the vehicles of which the leaving direction is right-turn appear at and after the time 10:00:35. Therefore, in the time zone at and after the time 10:00:00 and before the time 10:00:45, it is possible to consider that the lighting pattern illustrated in FIG. 3A is switched into the lighting pattern illustrated in FIG. 4A in the right-turn leaving time zone T₁ᵣ at and after the time 10:00:35 so that the specified leaving time zone can be specified.

According to the foregoing processing, it is possible to specify the lighting duration time of the lighting pattern which permits the passage of the vehicle approaching to the signalized intersection in the specified approach direction, and the lighting duration time of the lighting pattern which permits the passage of the vehicle leaving therefrom in the specified leaving direction, so that the lighting pattern of the current traffic signal can be precisely specified.

Note that in this embodiment, the cost information 30c is generated based on the corresponding relationship between the lighting pattern and the lighting duration time in the aforementioned manner. Thus, a statistical processing is performed for the lighting duration time of each lighting pattern. Specifically, when the processing shown in FIG. 2 is repeatedly performed, the information to associate each lighting pattern with the lighting duration time is generated more than once. The control unit 20 acquires a representative value (e.g., mean value, mode value, median value or the like) of the lighting duration time of each lighting pattern based on the information. The control unit 20 then determines the cost of the traveling direction which is allowed for the vehicles by each lighting pattern based on the ratio between the representative value of the lighting duration time of each lighting pattern and the reference value of each lighting pattern (e.g., average lighting duration time), and records it to the storage medium 30 as the cost information 30c.

The cost is an index referring to whether the traveling in the traveling direction allowed for the vehicle in each lighting pattern is more difficult than the other traveling directions. For example, it can be configured such that when the cost, which is associated with the default lighting duration time, is “100,” the costs of the traveling directions associated with the lighting patterns having the twice or half lighting duration time of the default lighting duration time are “50” and “200,” respectively.

Such cost information 30c is transmitted to the navigation system 100, and the control unit 200 of the navigation system 100 conducts the route search based on the cost information 30c by the processing of the guidance control unit 210c. Moreover, the guidance for having the vehicle driven on the searched route is output to the guide unit 430. As a result, it is possible to precisely search easy-to-drive routes while taking into consideration of the lighting pattern of the traffic signal, and moreover to guide the route.

### 3 Other Embodiments

The above embodiment is an example for implementing the invention, and other various embodiments can be employed as long as the information on the lighting pattern of the traffic signal is acquired based on the traveling direction of the vehicles at the signalized intersection. For example, as for the probe information, it is sufficient to acquire the information at least on the traveling direction of the vehicle, and the information on the physical change of the vehicles, such as position change, velocity change, or acceleration change of the vehicles, may be employed, and the information on the road section where the vehicle travels and the direction thereof before and after the intersection may be employed, and thus various configurations can be employed.

As for the lighting pattern information acquiring unit, it is sufficient to acquire the information on the lighting pattern of the traffic signal based on the traveling direction information of the plurality of vehicles, and thus the traveling directions of the plurality of vehicles at a signalized intersection are acquired to specify the traveling direction of the vehicles which the traffic signal at the signalized intersection allows.

In the aforementioned embodiment, the information on the lighting pattern of the traffic signal is comprised of the information indicating lighting pattern with the lighting duration time, but it is sufficient that the information on the lighting pattern corresponds to the traveling direction which is allowed for the vehicles at the signalized intersection, and thus various aspects can be employed. For example, the information on the position or color of the lighting lamp of the traffic signal may be employed. Of course, the lighting pattern of the traffic signal is switched depending on the time. Therefore, the information on the lighting pattern preferably includes the information on each lighting pattern switched depending on the time. With such information, it is possible to specify the signal indication of the traffic signal.

Moreover, the lighting pattern may be defined in association with the date and time. At some signalized intersections, the type of lighting pattern or the lighting duration time of each lighting pattern changes according to the date and time even at the same signalized intersection. Therefore, the information can be defined by various aspects such as the configuration in which the date and time is associated with each lighting pattern, e.g., the configuration in which at the date and time when one lighting pattern may appear, the date and time when each lighting pattern has the specified lighting duration time is defined, or the lighting pattern, which may be generated in each unit of time, and the lighting duration time are defined every unit of time. Of course, the date and time which is associated with each lighting pattern may be defined every date, may be defined every week, or may be defined every season, and thus various configurations can be employed.

In addition to the aforementioned examples, the lighting pattern of the traffic signal has many examples. For example, at the intersection at which the straight roads cross, there is a traffic signal which permits both the vehicles traveling in the orthogonal directions only when the vehicles leave in the specified leaving direction to enter the signalized intersection. In this case, the orthogonal direction serves as the specified approach direction (the specified direction) which is allowed by the specified lighting pattern. Moreover, the specified leaving time zone is not limited to the configuration in which it begins in the middle of the time zone, in which the passage in the specified approach direction is allowed as in the above embodiment, and thus the specified leaving time zone may begin from the beginning of the time zone. Therefore, the lighting pattern may be configured such that only the vehicles leaving in the specified leaving direction are allowed to pass from the beginning to the middle of the time zone and the vehicles leaving in the specified direction and other leaving directions are allowed to pass from the middle of the time zone.

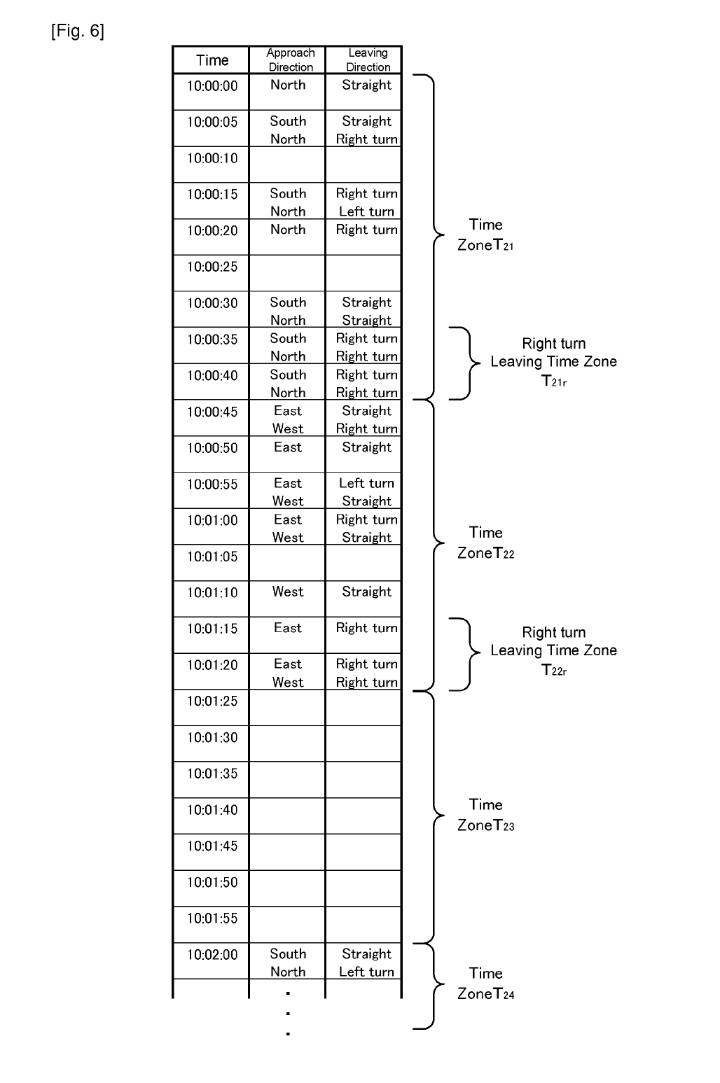

Furthermore, the invention may be applied to the signalized intersection including the lighting pattern prohibiting the passage of vehicles. FIG. 6 is a diagram illustrating an example of the approach direction and the leaving direction of the vehicle passing the signalized intersection. In the figure, since the approach direction and the leaving direction similar to in FIG. 5 are observed during the time period at and after the time 10:00:00 and before the time 10:01:25, the lighting duration time is associated with each lighting pattern associated with the time zone as in FIG. 5.

However, during the time period at and after the time 10:01:25 and before the time 10:02:00, the time zone T₂₃, in which no vehicle passes the signalized intersection, is observed. In this case, in the time zone T₂₃, the right lamps of the traffic signals S₁ to S₄ are lighting, in other words, the lighting pattern prohibits the approach to the signalized intersection in all the northward, southward, eastward, and westward approach directions, as illustrated in FIG. 4B. At this time, the lighting pattern permits pedestrians to pass by a pedestrian traffic signal not shown.

Here, if it is determined whether the period during which no vehicle approaching to the signalized intersection is observed continues over a certain time interval, the time zone T₂₃, which is from the beginning of the period during which no vehicle is observed to the time at which the approach of the next vehicle is observed, can be considered as the lighting pattern permitting only the pedestrians to pass. Hence, the length of the time zone T₂₃ can be considered as the lighting duration time of the lighting pattern permitting only the pedestrians to pass.

Note that since the lighting pattern permitting only the pedestrians to pass prohibits the passage of the vehicles, the lighting duration time of the lighting pattern contributes to increase the difficulty in traveling at the signalized intersection for the vehicles. Therefore, if the cost indicating the difficulty in traveling is decided, the cost may be set such that as the lighting duration time of the lighting pattern permitting only the pedestrian to pass is longer, the cost for the vehicle's traveling to each traveling direction becomes larger.

1. A signalized intersection information acquiring device comprising:
a traveling direction information acquiring unit for acquiring traveling direction information indicating a traveling direction of a vehicle at a signalized intersection from a plurality of vehicles and a passing time at which the vehicle passes the signalized intersection; and
a lighting pattern information acquiring unit for acquiring information on a lighting pattern of a traffic signal at the signalized intersection and information on a lighting duration time of the lighting pattern of the traffic signal based on the traveling direction information of the plurality of vehicles.

2. The signalized intersection information acquiring device according to claim 1, wherein the lighting pattern information acquiring unit specifies an approach direction, in which the vehicle enters the signalized intersection, based on the traveling direction and the passing time, and specifies a time zone in which the specified approach direction is continuously observed to consider a breakpoint of the time zone as a switching timing of the lighting pattern.

3. The signalized intersection information acquiring device according to claim 2, wherein the lighting pattern information acquiring unit specifies a leaving direction, in which the vehicle leaves the signalized intersection, based on the traveling direction and the passing time, and specifies a specified leaving time zone in which only the specified leaving direction is continuously observed in every time zone to consider a breakpoint of the specified leaving time zone as a switching timing of the lighting pattern.

4. The signalized intersection information acquiring device according to claim 3, wherein
the lighting pattern information acquiring unit specifies the lighting duration time of the lighting pattern of the traffic signal based on the time zone and/or the specified leaving time zone.

5. The signalized intersection information acquiring device according to claim 1, wherein the lighting pattern information acquiring unit acquires an index indicating difficulty in traveling when traveling in the specified traveling direction at the signalized intersection, based on the lighting duration time of the lighting pattern, the index being used to search a route to a destination.

6. A method for acquiring signalized intersection information, comprising:
a traveling direction information acquiring step of acquiring traveling direction information indicating a traveling direction of a vehicle at a signalized intersection from a plurality of vehicles and a passing time at which the vehicle passes the signalized intersection; and
a lighting pattern information acquiring step of acquiring information indicating a lighting pattern of a traffic signal at the signalized intersection and information on a lighting duration time of the lighting pattern of the traffic signal based on the traveling direction information of the plurality of vehicles.

7. A signalized intersection information acquiring program for having a computer implemented:
a traveling direction information acquiring function for acquiring traveling direction information indicating a traveling direction of a vehicle at a signalized intersection from a plurality of vehicles and a passing time at which the vehicle passes the signalized intersection; and
a lighting pattern information acquiring function for acquiring information indicating a lighting pattern of a traffic signal at the signalized intersection and information on a lighting duration time of the lighting pattern of the traffic signal based on the traveling direction information of the plurality of vehicles.

8. The signalized intersection information acquiring device according to claim 4, wherein the lighting pattern information acquiring unit acquires an index indicating difficulty in traveling when traveling in the specified traveling direction at the signalized intersection, based on the lighting duration time of the lighting pattern, the index being used to search a route to a destination.
